(19) United States
(12) Patent Application Publication
(10) Pub. No.: US 2024/0025585 A1
(43) Pub. Date: Jan. 25, 2024

(54) CLAMPING ASSEMBLY

(71) Applicant: ABB Schweiz AG, Baden (CH)

(72) Inventor: Jason Zerweck, Philadelphia, PA (US)

(21) Appl. No.: 17/814,225

(22) Filed: Jul. 21, 2022

(51) Int. Cl. B65B 13/32; B25B 5/16

(52) U.S. Cl. CPC B65B 13/327; B25B 5/16

(57) ABSTRACT

A clamping apparatus for bundling a plurality of elongate articles using a weldable tape includes a guide block, an anvil bracket, a clamp body, an anvil, a pivot lever, at least one clamp spring, and at least one anvil spring. The guide block can include a passage extending through the guide block. The anvil bracket, the clamp body, and the anvil can be configured to slidably move in a forward and rear direction through a passage. The pivot lever can be configured to pivotably rotate about an axis and impart a translational movement onto the anvil bracket in response to a driving mechanism. The clamping assembly can be configured to complete a series of steps based on the translational movement of the pivot lever.

### FIELD

The present disclosure relates to a tool for dispensing a weldable material about a bundle of elongate articles. More particularly, the present disclosure relates to a clamping assembly for a tool for dispensing the weldable material about the bundle of elongate articles.

### BACKGROUND

Generally, a tool can be used for automatically bundling elongate articles such as wires, cables, or the like. For example, such a tool can feed a weldable tape about the bundled articles until the tape overlaps itself, tensioning the tape about the bundle of articles, and thereafter welding the tape at the location of the overlap to provide a tensioned loop which secures the bundle of articles. The tensioned loop can then be cut free from the remaining stock of tape so that the tool can be removed from the first bundle of articles and moved to a second location to secure a second portion of tape about a second bundle of articles.

### SUMMARY

In some embodiments, a clamping apparatus for bundling a plurality of elongate articles using a weldable tape, the clamping apparatus having a first side and a second side, the clamping apparatus includes: a guide block defined by a body, the guide block including: a passage extending through the guide block from a forward end of the guide block to a rear end; an anvil bracket; a clamp body; a pivot lever; at least one clamp spring providing a clamp force between the anvil bracket and the clamp body; at least one anvil spring providing a welding force between the anvil bracket and the guide block; and an anvil; wherein the anvil bracket, the clamp body, and the anvil are configured to slidably move in a forward and rear direction through the passage; wherein the pivot lever is configured to pivotably rotate about an axis and impart a translational movement onto the anvil bracket in response to a driving mechanism.

In some embodiments, the clamping assembly is configured to complete a series of steps based on the translational movement of the pivot lever.

In some embodiments, the pivot lever further includes: a first lever arm, wherein the first lever arm includes a first guide wheel in rolling engagement with the driving mechanism, a second lever arm, wherein the second lever arm includes a second guide wheel in rolling engagement with the anvil bracket, and a third lever arm, wherein the third lever arm includes being configured to pivotably mount to the guide block.

In some embodiments, the apparatus further includes: a first bearing; wherein the anvil bracket includes a first aperture configured to receive the first bearing; wherein the clamp bracket includes a second aperture configured to receive the first bearing; wherein the first bearing is disposed in the first aperture and the second aperture in the passage of the guide block.

In some embodiments, the apparatus further includes: a second bearing; wherein the anvil bracket includes a third aperture configured to receive the second bearing; wherein the clamp bracket is configured to accommodate, at least in part, the second bearing; wherein the second bearing is disposed in the third aperture in the passage of the guide block.

In some embodiments, the at least one clamp spring includes: a first clamp spring, and a second clamp spring, wherein the first clamp spring and the second clamp spring are disposed on opposites sides of the guide block.

In some embodiments, the at least one anvil spring includes: a first anvil spring, and a second anvil spring, wherein the first anvil spring and the second anvil spring are disposed on opposite sides of the guide block.

In some embodiments, the guide block further includes: a first part disposed on the first side, a second part disposed on the second side, wherein the first member and the second member are configured to form the guide block.

In some embodiments, the clamp body includes a first member and further includes a second member disposed at the forward end of the clamp body configured to engage the weldable tape during a bundling operation.

In some embodiments, the anvil includes: a first anvil arm, a second anvil arm, a slot extending through each of the first anvil arm and the second anvil arm, a pin fixedly disposed in the passage of the guide block and extending through each slot of the first anvil arm and the second anvil arm wherein the first anvil arm and the second anvil arm are configured to outwardly extend when moving in the forward direction and inwardly retract when moving in the rear direction based on the slot and pin configuration.

In some embodiments, a tool for bundling a plurality of elongate articles using weldable tape, the tool having a first side and a second side and including: a clamping assembly includes: a guide block defining a body, the guide block including: a passage extending through the guide block from a forward end to the rear end of the guide block, an anvil bracket, a clamp body, an anvil, a pivot lever, at least one clamp spring providing a clamping force between the clamp body and the anvil bracket, at least one anvil spring providing a welding force between the anvil bracket and the guide block, a first bearing, a second bearing, wherein the anvil bracket, the clamp body, and the anvil are configured to slidably move in a forward and rear direction through the passage; wherein the pivot lever is configured to pivotably rotate about an axis and impart a translational movement onto the anvil bracket in response to a driving mechanism.

In some embodiments, the clamping assembly is configured to complete a series of steps based on the translational movement of the pivot lever.

In some embodiments, the pivot lever further includes: a first lever arm, wherein the first lever arm includes a first guide wheel in rolling engagement with the driving mechanism, a second lever arm, wherein the second lever arm includes a second guide wheel in rolling engagement with the anvil bracket, and a third lever arm, wherein the third lever arm includes being configured to pivotably mount to the guide block.

In some embodiments, the anvil bracket includes a first aperture configured to receive the first bearing; wherein the clamp bracket includes a second aperture configured to receive the first bearing; wherein the first bearing is disposed in the first aperture and the second aperture in the passage of the guide block.

In some embodiments, the anvil bracket includes a third aperture configured to receive the second bearing; wherein the clamp bracket is configured to accommodate, at least in part, the second bearing; wherein the second bearing is disposed in the third aperture in the passage of the guide block.

In some embodiments, the at least one clamp spring includes: a first clamp spring, and a second clamp spring, wherein the first clamp spring and the second clamp spring are disposed on opposites sides of the guide block.

In some embodiments, the at least one anvil spring includes: a first anvil spring, and a second anvil spring, wherein the first anvil spring and the second anvil spring are disposed on opposite sides of the guide block.

In some embodiments, the guide block further includes: a first part disposed on the first side, a second part disposed on the second side, wherein the first member and the second member are configured to form the guide block.

In some embodiments, the clamp body includes a first member and further includes a second member disposed at the forward end of the clamp body configured to engage the weldable tape during a bundling operation.

In some embodiments, the anvil includes: a first anvil arm, a second anvil arm, a slot extending through each of the first anvil arm and the second anvil arm, a pin fixedly disposed in the passage of the guide block and extending through each slot of the first anvil arm and the second anvil arm wherein the first anvil arm and the second anvil arm are configured to outwardly extend when moving in the forward direction and inwardly retract when moving in the rear direction based on the slot and pin configuration.

### BRIEF DESCRIPTION OF THE DRAWINGS

References are made to the accompanying drawings that form a part of this disclosure and that illustrate embodiments in which the systems and methods described in this Specification can be practiced.

FIG. 1 is a side view of a tool, according to some embodiments.

FIG. 2 is a side view of a clamping assembly of the tool of FIG. 1, according to some embodiments.

FIG. 3 is a perspective view of the clamping assembly, according to some embodiments.

FIG. 4 is a side view of the clamping assembly, according to some embodiments.

FIG. 5 is a partial side view of the clamping assembly, according to some embodiments.

FIG. 6 is a top view of the clamping assembly, according to some embodiments.

FIGS. 7-14 are side views of the clamping assembly, according to some embodiments.

Like reference numbers represent the same or similar parts throughout.

### DETAILED DESCRIPTION

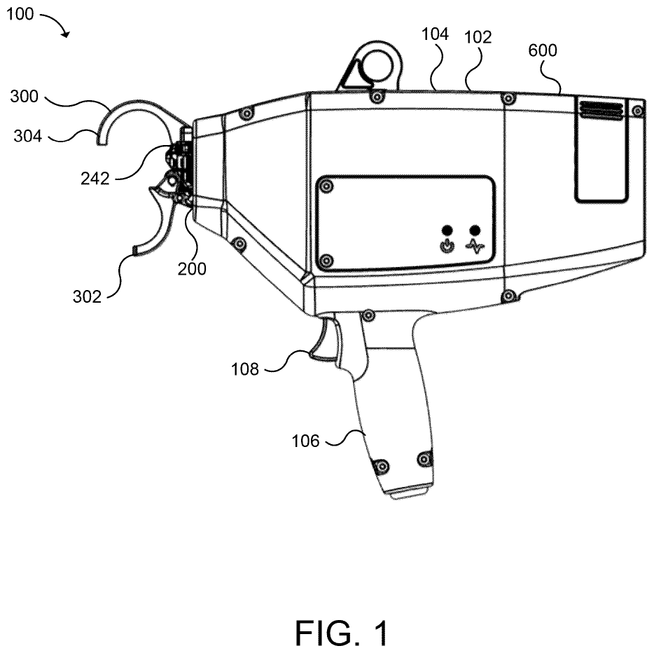

FIG. 1 shows a side view of a tool 100, according to some embodiments. The tool 100 can be referred to as an ultrasonic tying tool or the like. The tool 100 includes a housing 102 having a first side, a second side, a forward end, and a rear end. In the illustrated embodiment, the housing 102 is pistol-shaped. The housing 102 includes a body 104 and a handle 106. The handle 106 can include a trigger 108. It is to be appreciated that other geometries for the housing are possible and that pistol-shaped is an example. Additional geometries are possible in accordance with the remaining disclosure.

In some embodiments, the trigger 108 can be utilized by a user to operate the tool 100. Squeezing of trigger 108 operates a switch (not shown) electrically communicating with a control mechanism (not shown). As will be recognized by those skilled in the art, the control mechanism may, for example, include a programmed microchip contained internally within the tool 100 or external to the tool 100 (e.g., the microchip and power supply can be combined together into one unit). The control mechanism provides power and instructions to the components of the tool at appropriate points during the bundling operation.

The tool 100 includes a clamping assembly 200. In some embodiments, the clamping assembly 200 can be located proximate to the forward end of the tool 100. The clamping assembly 200 can be referred to as a clamping apparatus or the like. In some embodiments, the tool 100 can include a jaw assembly 300 and a cartridge assembly 600. The jaw assembly 300 can include a jaw 302 and a jaw 304. The drive assembly 400 can be configured to enclose the jaw 302 and the jaw 304 around the plurality of elongate articles to wrap the elongate articles with the weldable tape during a bundling operation of the tool 100. The cartridge assembly 600 can include a length of weldable tape for the tool 100. The weldable tape can be fed through the tool 100 and can be secured around a plurality of elongate articles by the clamping assembly 200 and a drive assembly 400. According to some embodiments, the tool 100 can be configured for and/or capable of securing a weldable tape about a bundle of elongate articles and thereafter welding and cutting the tape without loss of tension in the bundled articles and reducing friction forces. It is to be appreciated that the tool 100 includes additional features for providing a tape material to the clamping assembly 200. However, unless specific reference is made otherwise, these additional components will not be discussed in additional detail.

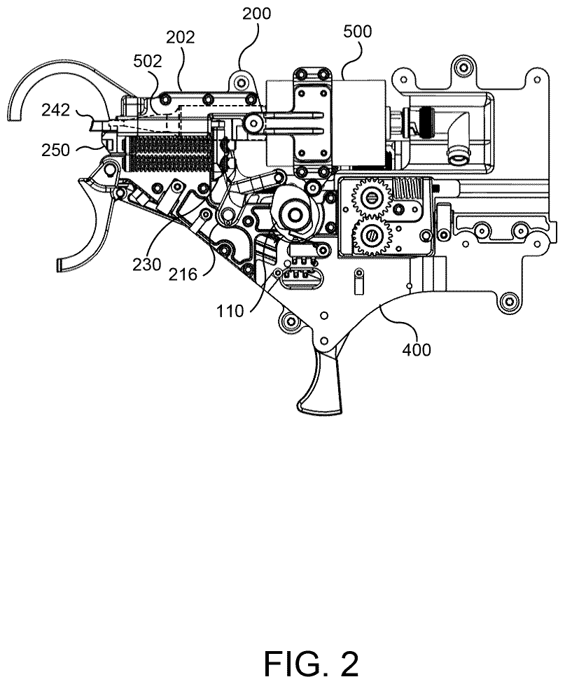

FIG. 2 shows a partially exposed view of the tool 100 of FIG. 1, according to some embodiments. In some embodiments, the tool 100 can include a drive assembly 400. In some embodiments, an operation of the clamping assembly 200 can be based on an operation of the drive assembly 400. In some embodiments, the clamping assembly 200 can be connected to the drive assembly 400. In some embodiments, the clamping assembly 200 can be in rolling engagement with the drive assembly 400. In some embodiments, the drive assembly 400 can include a cam 110. In some embodiments, the cam 110 can include an eccentric outer circumference. In some embodiments, the cam 110 can be fixedly mounted to an axle of a gear train, the gear train connected to a motor of the drive assembly. It is to be appreciated that the clamping assembly 200 is not intended to be limited by the drive assembly 400 and that the illustrated embodiments are exemplary. Additional means of moving the clamping assembly 200 is possible in accordance with the remaining disclosure. For example, the clamping assembly 200 may be mechanically coupled to a gear train to translate movement onto the clamping assembly 200 to cycle the operation of the clamping assembly 200. In another example, the movement of the clamping assembly 200 may be based on the movement of a translational actuator controlling the forward and rearward movement of the anvil bracket 230.

In some embodiments, the tool 100 can include a welding assembly 500. The welding assembly 500 can include a welding horn 502 extending through the clamping assembly 200 to the front end of the tool 100. In some embodiments, the welding horn 502 can extend through the guide block 202 to the front end of the tool as will be further discussed below.

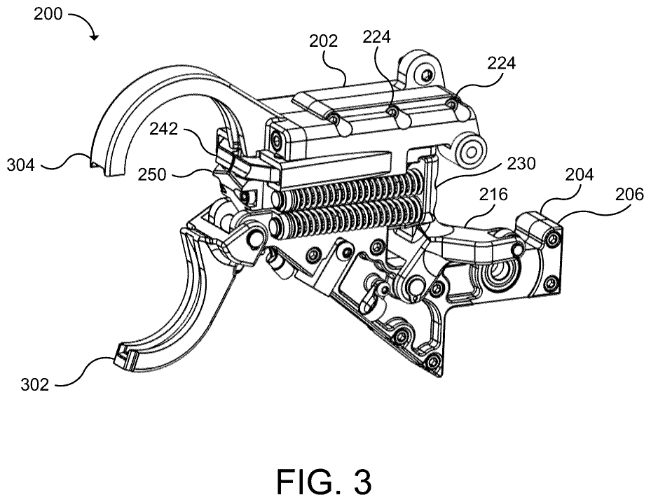

FIG. 3 shows a perspective view of the clamping assembly 200, according to some embodiments. In some embodiments, the clamping assembly 200 can include a guide block 202, an anvil bracket 230, a clamp body 250, and an anvil 242. In some embodiments, the clamping assembly 200 can include a pivot lever 216. The guide block 202 can be defined by a body. In some embodiments, the body of the guide block 202 can define a passage extending therethrough from the front end to the rear end of the guide block 202. In some embodiments, the passage of the guide block 202 can include any appropriate dimensions to accommodate the anvil bracket 230, clamp body 250, anvil 242, welding assembly 500 (FIG. 2), other components of the tool 100, and any portions thereof, in the passage.

In some embodiments, the guide block 202 can include a second passage (not pictured) extending from the rear end of the guide block 202 to the forward end of the guide block 202 configured to receive the weldable tape. In some embodiments, the second passage can receive the weldable tape from the drive assembly 400 (FIG. 2) and the second passage can extend towards the front of the tool 100 to feed the weldable tape out into the drive assembly 400. In some embodiments, the second passage for the weldable tape can include any appropriate dimensions to allow the tape to feed through the passage without seizing or buckling.

In some embodiments, the guide block 202 can include a first part 204 and a second part 206. In some embodiments, the first part 204 and the second part 206 can form the first side and the second side of the guide block 202, respectively. In some embodiments, the first part 204 and the second part 206 can be coupled together to form the guide block 202. In some embodiments, each of the first part 204 and the second part 206 can include a plurality of bores 224. In some embodiments, each bore 224 on the first part 204 can align with each bore 224 on the second part 206 and can be configured to receive a fastener to couple the first part 204 to the second part 206. In some embodiments, an inner surface of each bore 224 can be smooth, threaded, and combinations thereof. In some embodiments, the fastening element can include, but is not limited to, screws, bolts, nuts, clips, rivets, pins, latches, solder, other fasteners, and combinations thereof.

In some embodiments, the guide block 202 can include a physical stop located at the forward end of the guide block 202. In some embodiments, the physical stop can act to limit a movement of the anvil bracket 230 in the forward direction. For example, in case of failure of the springs. In the illustrated embodiments, the geometry of the guide block is shaped to conform to the forward end of the housing 102 and/or to accommodate components of the clamping assembly 200. The geometry of the guide block can also be shaped to connect to other components of the tool 100. It is to be appreciated that other geometries for the guide block 202 are possible and that the illustrated embodiments are exemplary. Additional geometries are possible in accordance with the remaining disclosure.

In some embodiments, the clamping assembly 200 can include the pivot lever 216. In some embodiments, the pivot lever 216 can be in rolling engagement with the drive assembly 400. In some embodiments, the pivot lever 216 can be in rolling engagement with the eccentric outer circumference of the cam 110 of the drive assembly 400. Consequently, the pivot lever 216 can pivotably move about an axis in response to a rotation of the cam 110.

In some embodiments, the movement of the clamping assembly 200 can be based on any of a plurality of devices including, but not limited to, actuators, motors, pneumatic devices, valves, rods, pistons, hinges, springs, gears, other translational devices, and combinations thereof. In some embodiments, the tool 100 can include a translational actuator (not pictured). In some embodiments, the movement of the clamping assembly 200 can be based, in part, on the movement of the translational actuator. In some embodiments, the forward and rearward movement of the anvil bracket 230 can be based, at least in part, on actuation of a translational actuator.

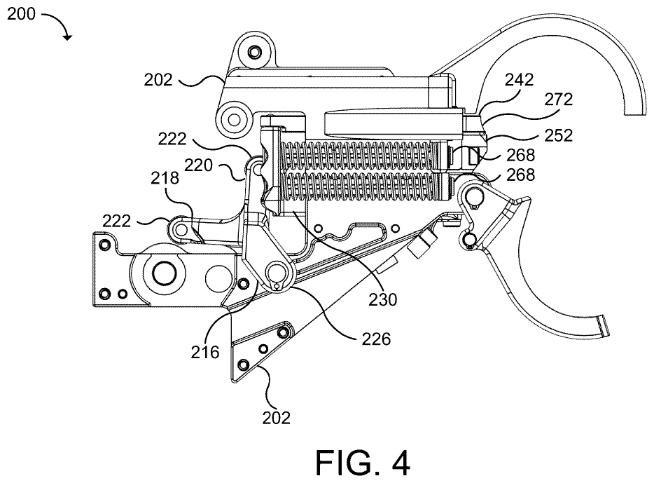

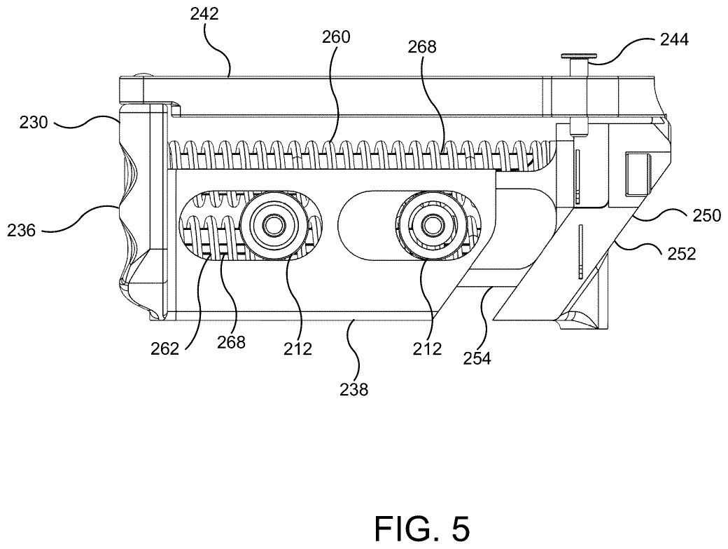

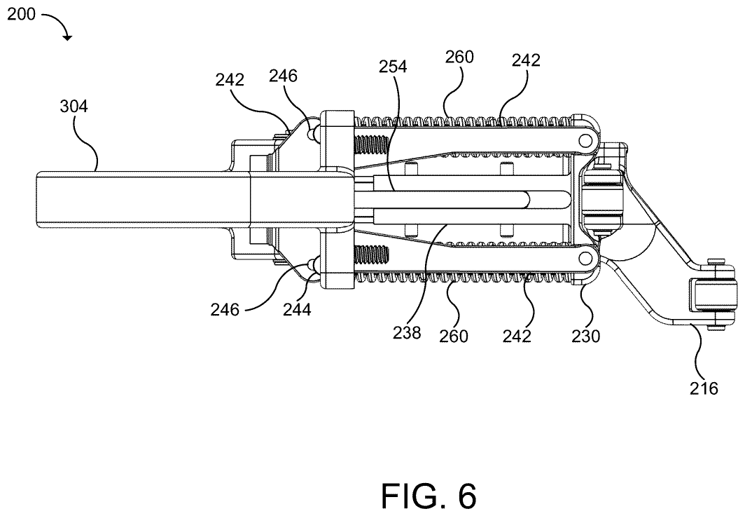

FIG. 4 shows a side view of the clamping assembly 200, according to some embodiments. FIG. 5 shows a partial side view of the clamping assembly 200, according to some embodiments. FIG. 6 shows a top view of the clamping assembly 200, according to some embodiments.

Referring to FIG. 4, in some embodiments, the clamping assembly 200 can include a pivot lever 216. In some embodiments, the pivot lever 216 can include a first arm 218 and a second arm 220. The first arm 218 can be in contact with a driving mechanism and imparts a translational movement onto the anvil bracket 230 in response to an operation of the driving mechanism. Consequently, in some embodiments, the driving mechanism can control a movement of the clamping assembly 200. In some embodiments, the driving mechanism can be the driving assembly. In some embodiments, the first arm 218 can be attached to the driving mechanism. In some embodiments, the first arm 218 can include a guide wheel 222 at an end of the first arm 218. In some embodiments, the guide wheel 222 can be in rolling engagement with the driving mechanism. In some embodiments, the driving mechanism can include the cam 110 (FIG. 2). In some embodiments, the cam 110 (FIG. 2) can include a plurality of eccentric surfaces and a rotation of the cam 110 (FIG. 2) about an axis can cause the pivot lever 216 to pivot relative to the guide block 202.

In some embodiments, the second arm 220 can be in contact with a rear surface of the anvil bracket 230. In some embodiments, the second arm 220 can be connected to the anvil bracket 230. In some embodiments, the second arm 220 can include a guide wheel 222 located at an end of the second arm 220. In some embodiments, the guide wheel 222 of the second arm 220 can be in rolling engagement with the anvil bracket 230. Consequently, in some embodiments, the pivotal movement of the pivot lever 216 in response to the drive mechanism acting on the first arm 218 can cause a translational movement onto the second arm 220. Further, in some embodiments, the translational movement of the pivot lever 216 can cause a movement of the anvil bracket 230 as will be further discussed below.

In some embodiments, pivot lever 216 can pivotably move about an axis relative to the guide block 202. In some embodiments, the pivot lever 216 can include a third arm 226. In some embodiments, the third arm 226 can be configured to connect the guide block 202 to allow the pivot lever 216 to pivotably move about an axis in response to the operation of the drive mechanism. In some embodiments, the third arm 226 can include an aperture extending from the first side to the second side of the third arm 226 proximal to a distal end of the third arm 226. In some embodiments, the aperture of the third arm 226 can be configured to receive a lever pin assembly through the third arm 226 and the guide block 202 to allow the pivot lever 216 to pivot relative to the guide block 202. Consequently, in some embodiments, the guide block 202 can include a bore laterally extending through the guide block 202 from the first side to the second side to allow the lever pin assembly to extend through the guide block 202 to rotatably connect the pivot lever 216 to the guide block 202. In some embodiments, the third arm 226 can include a first member and a second member extending from the central body of the pivot lever 216 configured to be positioned on the first side and the second side, respectively, of the guide block 202. Further, in some embodiments, the first member and the second member can include an aperture at the distal end of each of the first member and the second member configured to receive the lever pin assembly. Consequently, in some embodiments, the pivot lever 216 can be pivotably connected to the guide block 202 by installing the pin assembly through the first member, the guide block, and the second member. In some embodiments, each arm of the pivot lever 216 can extend on a first plane. In some embodiments, the first arm 218 can extend on a first plane and the second arm 220 and the third arm 226 can extend on a second plane, the first plane parallel to the second plane. In some embodiments, the first member and the second member of the third arm 226 can extend parallel to the second plane.

Referring to FIG. 5, the clamping assembly 200 can include the anvil bracket 230. The anvil bracket 230 can move in a forward direction and a rear direction in the passage of the guide block 202. In some embodiments, the movement of the anvil bracket 230 in the forward and the rear direction can be based on the spring 262, the position of the pivot lever 216, and combinations thereof. In some embodiments, the anvil bracket 230 can include a first member 236 and a second member 238. The first member 236 can be located at the rear end of the clamping assembly 200. In some embodiments, the first member 236 can include, at least in part, a substantially planar surface in rolling engagement with the guide wheel 232 of the second arm 220. In some embodiments, the first member 236 can include guide bores extending through the first member 236 on opposing sides of the second member 238. The guide bores can allow guide member 268 to extend through the first member 236. In some embodiments, the anvil bracket 230 can be attached to the guide member 268. In some embodiments, the anvil bracket 230 can be coupled to an end of the guide member 268 with a fastener. In some embodiments, the fastener for the guide member 268 can include, but is not limited to, screws, clips, pins, rivets, nuts, bolts, solder, other fasteners, and combinations thereof. In some embodiments, the anvil bracket 230 can include two guide bores. In some embodiments, the anvil bracket 230 can include four guide bores. In some embodiments, the anvil bracket 230 can include more than four guide bores.

The second member 238 can extend from the first member 236 towards the front end of the tool 100. In some embodiments, the second member 238 can include a channel extending along a length of the second member 238 from the front end of the second member 238 and towards the first member 236. In some embodiments, the channel can extend through a portion of the second member 238. In some embodiments, the channel can extend substantially through the second member 238. The dimensions of the channel can be configured to allow the clamp body 250 to extend through the channel as will be further discussed below.

In some embodiments, the second member 238 can include at least one aperture laterally extending through the second member 238. In some embodiments, the clamping assembly 200 can include at least one bearing 212 in the at least one aperture. Consequently, in some embodiments, the anvil bracket 230 can move in the forward and rear direction in rolling engagement with the at least one bearing 212. In some embodiments, the at least one aperture can include appropriate dimensions to allow the anvil bracket 230 to move in the forward and rear directions during the cycling of the clamping assembly 200. In some embodiments, the at least one aperture of the second member 238 can be a first aperture and a second aperture, each aperture configured to receive a bearing 212.

The clamping assembly 200 can include the clamp body 250. The clamp body 250 can move in the forward and rear direction in the passage of the guide block 202 based on an operation of the clamping assembly 200. In some embodiments, the clamp body 250 can move in the forward direction and exert a clamping force onto the weldable tape. The clamping force can be exerted onto the weldable material to maintain a position of the weldable material. For example, the clamp body 250 can be moved in the forward direction to exert the clamping force onto overlapping segments of the weldable tape to retain the position of the overlapping segments during a welding operation.

In some embodiments, the clamp body 250 can include a third member 252 and a fourth member 254. The third member 252 can be disposed at the forward end of the clamping assembly 200. In some embodiments, the third member 252 can include two guide bores to allow the guide member 268 to extend through the guide bores. In some embodiments, the third member 252 can be attached to the guide member 268. In some embodiments, the clamp body 250 can be coupled to an end of the guide member 268 with a fastener. In some embodiments, the fastener for the guide member 268 can include, but is not limited to, screws, clips, pins, rivets, nuts, bolts, solder, other fasteners, and combinations thereof. In some embodiments, the clamp body 250 can include two guide bores. In some embodiments, the clamp body 250 can include four guide bores. In some embodiments, the clamp body 250 can include more than four guide bores.

The fourth member 254 can extend from the third member 252 towards the rear of the clamping assembly 200. In some embodiments, the fourth member 254 can be disposed in the channel of the second member 238. In some embodiments, the fourth member 254 can include at least one aperture extending from the first side to the second side. In some embodiments, the at least one aperture of the fourth member 254 can be configured to allow the at least one bearing 212 to be disposed in the at least one aperture of the fourth member 254. In some embodiments, the at least one bearing 212 can reduce the friction for the clamp body 250 to slidably move in the forward and rear direction. In some embodiments, the clamping assembly 200 can include a first bearing 212 and a second bearing 212 and the at least one aperture of the second member 238 can include a first aperture and a second aperture for each bearing 212. In some embodiments, the fourth member 254 can include an aperture for a first bearing 212 towards the forward end of the fourth member 254 and can include an arcuate cutout for the second bearing 212 towards the rear end of the clamp body 250.

In some embodiments, the clamp body 250 can include teeth at the forward end of the clamp body 250 to engage the weldable tape when the clamp body 250 clamps onto the weldable tape. In some embodiments, the clamp body 250 can include a cutting edge disposed near the forward end of the clamp body 250 and facing the rear of the clamping assembly 200. When the anvil 242 exerts the welding force onto the weldable tape and the welding horn 502 can be in a second welding/cutting position, the clamp body 250 can be retracted in the rearward direction to urge the cutting edge into contact with the weldable tape. In some embodiments, the clamp body 250 can include a grip member disposed at the forward end of the clamp body 250. In some embodiments, the grip member can include a profile that aligns with the forward end of the clamp body 250. In some embodiments, the gripping teeth and/or the cutting edge can be located on the grip member. In some embodiments, the grip member can be coupled to the clamp body 250 by fasteners, the clamp body 250 being further configured to receive the fasteners. In some embodiments, the fasteners can include screws, bolts, nuts, rivets, pins, solder, other fasteners, and combinations thereof.

In some embodiments, the clamping assembly 200 can include the at least one bearing 212. The at least one bearing 212 can be disposed in the passage of the guide block 202. In some embodiments, the at least one bearing 212 can be further disposed in the at least one aperture of the anvil bracket 230. In some embodiments, the at least one bearing 212 can be disposed in the at least one aperture of the clamp body 250. The at least one bearing 212 can reduce a friction loss of the anvil bracket 230 and/or the clamp body 250 in rolling contact with an outer circumference of the at least one bearing 212. In some embodiments, the clamping assembly 200 can include a pin extending through an inner circumference of the at least one bearing 212 to retain a position of the at least one bearing 212 in the guide block 202. Consequently, in some embodiments, the guide block 202 can be configured to accommodate the pins to retain the position of the at least one bearing 212 in the passage of the guide block 202. In some embodiments, the at least one bearing 212 can include a first bearing and a second bearing. In some embodiments, the at least one bearing 212 can include two or more bearings. In some embodiments, the at least one bearing 212 can include a first bearing and a second bearing. Further, in some embodiments, the first bearing can be located in the first aperture of the anvil bracket 230 and the first aperture of the clamp body 250 and the second bearing can be located in the second aperture of the anvil bracket 230 and the second aperture of the clamp body 250 and/or aligned with the arcuate cutout of the clamp body 250.

The clamping assembly 200 can include the spring 260. In some embodiments, the spring 260 can be referred to as a clamp spring. The spring 260 can be located on the side of the guide block 202 and between the rear end of the anvil bracket 230 and the forward end of the clamp body 250. The spring 260 can provide a compression force between the anvil bracket 230 and the clamp body 250 to allow the clamp body 250 to exert the clamping force onto the weldable tape. The outboard location of the spring can make replacing the spring or adjusting the clamping force easier and more convenient. In some embodiments, the spring 260 can include the guide member 274 extending through an interior of the spring 260 to retain a position of the spring 260. In some embodiments, the guide member 268 includes a first end and a second end. Further, in some embodiments, the guide member 268 extending through the interior of the spring 260 can be connected to the anvil bracket 230 at the first end and connected to the clamp body 250 at the second end. In some embodiments, the clamping assembly 200 can include a first spring 260 and a second spring 260. The first spring 260 can be disposed on the first side of the guide block 202 and the second spring 260 can be disposed on the second side of the guide block 202.

The clamping assembly 200 can include the spring 262. In some embodiments, the spring 262 can be referred to as an anvil spring. The spring 262 can be located on the side of the guide block 202 and between the rear end of the anvil bracket 230 and the forward end of the clamp body 250 proximal to the spring 260. The spring 262 can provide a compression force between the anvil bracket 230 and the guide block 202 to allow the anvil bracket 230 to exert a welding force onto the weldable tape with the anvil 242. In some embodiments, the spring 262 can include the guide member 274 extending through an interior of the spring 262 to retain a position of the spring 262. In some embodiments, the guide member 268 can extend through the interior of the spring 262 and can be connected to the anvil bracket 230 at the first end and to the physical stop of the guide block 202 at the second end. In some embodiments, the clamping assembly 200 can include a first spring 262 and a second spring 262. The first spring 262 can be disposed on the first side of the guide block 202 and the second spring 262 can be disposed on the second side of the guide block 202.

The clamping assembly 200 can include the anvil 242. The anvil 242 can be attached to the anvil bracket 230 and extend through the passage of the guide block 202. In some embodiments, the anvil 242 can be attached proximate to the rear end of the anvil bracket 230. In some embodiments, the anvil 242 can be attached to the first member 236. In some embodiments, the anvil 242 can be coupled to the anvil bracket 230 with fasteners. In some embodiments, the fasteners can include, but is not limited to, screws, bolts, nuts, pins, rivets, clips, solder, other fasteners, and combinations thereof. In some embodiments, the anvil 242 can move in the forward direction in response to the forward movement of the anvil bracket 230. In some embodiments, the anvil 242 can be configured to laterally extend outward around the weldable tape as the anvil 242 moves in the forward direction and can be configured to laterally extend inward as the anvil 242 moves in the rear direction.

Referring to FIG. 6, in some embodiments, the anvil 242 can include a first arm and a second arm. In some embodiments, the forward end of each arm of the anvil 242 can be shaped to engage a surface of the weldable tape as each arm inwardly retracts towards the rear direction. In some embodiments, each of the first arm and the second arm of the anvil 242 can be configured to extend laterally outward using a pin and slot design. Consequently, in some embodiments, each arm on the anvil 242 can include a slot 246 vertically extending through a length of each arm. The slot 246 in each arm can be shaped so that each arm can laterally extend outward as the anvil 242 moves in the forward direction. For example, the distance between the slot 242 of the first arm and the second arm may be wider at the forward end of the anvil 242 and narrower at the rear end of the slot. In some embodiments, the clamping assembly 200 can include a pin 244 for each arm of the anvil 242. In some embodiments, the pin 244 can vertically extend through the slot 246 of each arm and can be affixed in position in the passage of the guide block 202 in the slot 242. Consequently, in some embodiments, the forward translational movement of the anvil 242 based on the forward movement of the anvil bracket 230 can cause each of the first arm and the second arm to outwardly extend as each pin 242 travels along the length of the slot 242 on each arm.

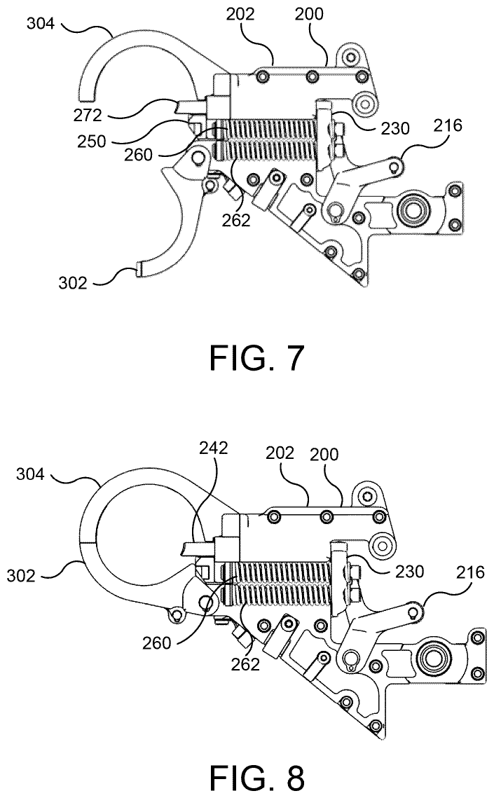

The operation of the tool 100 will be described in more detail with reference to FIGS. 7-14. The tool can be preferably programmed to run through a series of steps during one complete cycle.

FIG. 7 shows the side view of the clamping assembly 200, according to some embodiments. During a first step of the cycle, the jaw 302 and the jaw 304 can be in the open position. The pivot lever 216 can be in the forward position. In some embodiments, the position of the pivot lever 216 can be based on the position of the cam 110. In some embodiments, the position of the pivot lever 216 can be based on the cam 110 being in a “home” position. In the first step of the cycle, the anvil bracket 230 can be in a maximum forward position and the clamp body 250 can be sprung forward. Further, based on the position of the anvil bracket 230, the anvil 242 are extended in the forward direction from the housing 102 and can be open a maximum distance laterally due to the pin 244 and slot 246 arrangement for each anvil 242. The clamp body 250 can be sprung forward due to the clamping force of the spring 260 and the weldable tape can be located at a tip of the clamp body 250.

FIG. 8 shows the side view of the clamping assembly 200 of the tool 100, according to some embodiments. During a second step of the cycle, the jaw 302 can be hinged closed. Further, the pivot lever 216 can be in the forward position. In some embodiments, the position of the pivot lever 216 can be based on the cam 110 being in the home position. In the second step of the cycle, the anvil bracket 230 can be in the forward position and the clamp body 250 can be sprung forward. Further, the anvil 242 are extended in the forward direction and extended laterally from the housing 102 based on the position of the pivot lever 216.

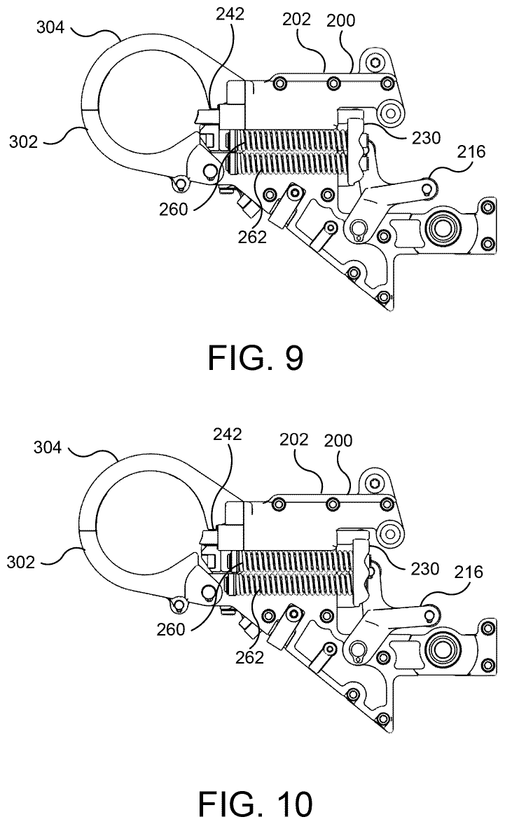

FIG. 9 shows the side view of the clamping assembly 200, according to some embodiments. During a third step of the cycle, the jaw 302 can be in the closed position. The pivot lever 216 can be in a partially closed position compared to the first step of the cycle. In some embodiments, the pivot lever 216 can be in the partially closed position based on the orientation of the cam 110. In some embodiments, the partially closed position can be the anvil bracket 230 sprung partially in the rear direction. In the third step of the cycle, the anvil bracket 230 can be partially closed and the clamp body 250 can be sprung forward. Further, the anvil 242 can be partially closed in the lateral direction based on the pin 244 and slot 246 arrangement. The weldable tape can be fed around the jaws and through the anvil 242 until a double thickness loop can be created between the anvils and clamp. The partially closed anvil 242 can help guide the weldable tape as it feeds around the inner circumference of jaw 302 and jaw 304.

FIG. 10 shows the side view of the clamping assembly 200, according to some embodiments. During a fourth step of the cycle, the jaw 302 can be closed. The anvil bracket 230 can be in a rearward position based on the position of the pivot lever 216. In some embodiments, the pivot lever 216 position can be based on the orientation of the cam 110 in a “clamp” position. In the fourth step of the cycle, the anvil 242 are in the rearward position to apply at least a portion of the welding force onto the weldable tape and to retain the double thickness weldable tape between the anvil 242 and the clamp body 250. The clamp body 250 can be sprung forward. The weldable tape can be tensioned around the bundle of elongate articles.

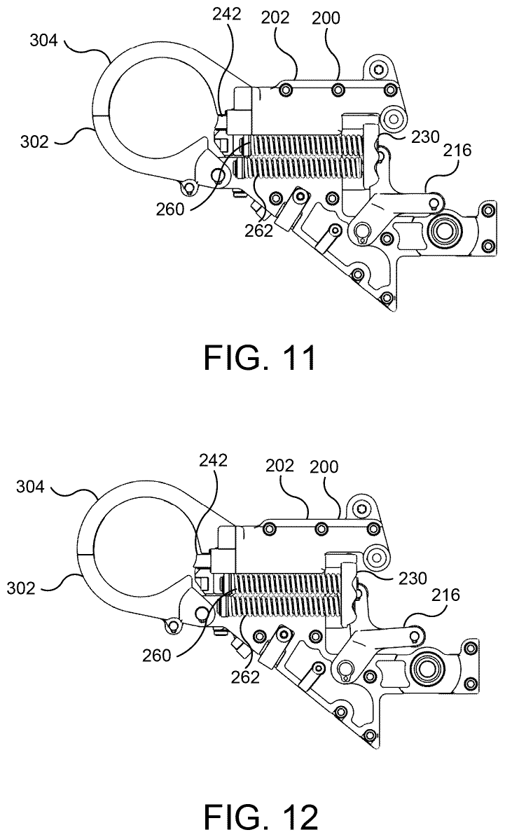

FIG. 11 shows the side view of the clamping assembly 200, according to some embodiments. During a fifth step of the cycle, the jaw 302 can be closed. The anvil bracket 230 can be in a rearward position based on the position of the pivot lever 216. In some embodiments, the pivot lever 216 position can be based on the cam 110 being in a “weld” position. In the fifth step of the cycle, the anvil 242 can be moved back to apply the welding force onto the weldable tape and the weldable tape contacts the welding horn 502. The clamp body 250 moves back with the anvil 242 and the weldable tape towards the welding horn 502 in response to the welding force. The welding horn 502 can be activated to weld the double loops of the weldable tape together. The weldable tape can be welded around the elongate articles.

FIG. 12 shows the side view of the clamping assembly 200, according to some embodiments. During a sixth step of the cycle, the jaw 302 can be closed. The anvil bracket 230 can be in a partially forward position based on the position of the pivot lever 216 being in a partially forward position. In some embodiments, the pivot lever 216 in the partially forward position can be based on the cam 110 being in a position between the weld and cut positions. In the sixth step of the cycle, the anvil 242 and the clamp body 250 are momentarily moved in the forward direction and the weldable tape can be partially released from the welding horn 502. Further, the welding horn 502 can be tilted downward to a second position on the weldable tape.

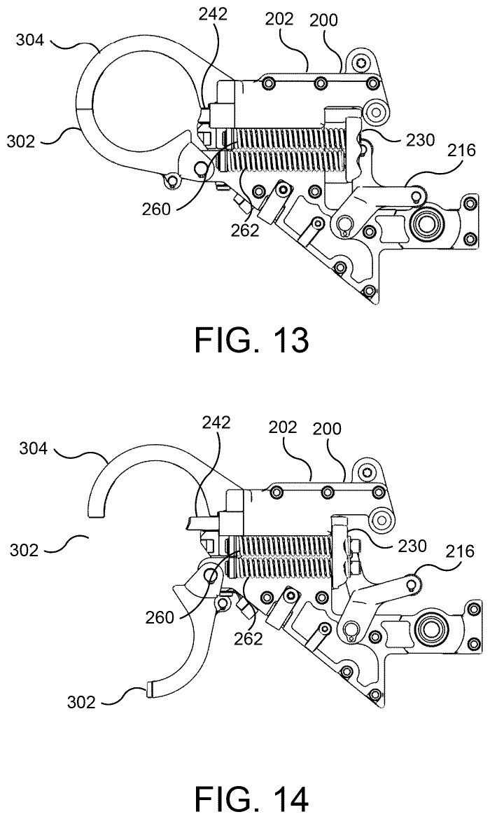

FIG. 13 shows a side view of the clamping assembly 200 of the tool 100, according to some embodiments. During a seventh step of the cycle, the jaw 302 can be closed. The anvil bracket 230 can be in the rearward direction based on the position of the pivot lever 216. In some embodiments, the position of the pivot lever 216 can be based on the cam 110 being in a “cut” position. In the seventh step, the anvil 242 can be moved in the rearward direction until the weldable tape contacts the welding horn 502 at the second position. The welding horn 502 welds the double loops of the weldable tape together at the second position. Once welded in the second position, the weldable tape can be cut free from the loop formed around the bundle of elongate articles.

FIG. 14 shows a side view of the clamping assembly 200, according to some embodiments. During an eighth step of the cycle, the jaw 302 can be in the open position. The anvil bracket 230 can be in the maximum forward position based on the pivot lever 216 being in the forward position. In some embodiments, the position of the pivot lever 216 can be based on the cam 110 being in the home position. In the eighth step of the cycle, the anvil 242 moves forward into the wide-open arrangement and the clamp body 250 moves forward. The jaw 302 can be automatically opened and the welding horn 502 returns to normal position.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A clamping apparatus for bundling a plurality of elongate articles using a weldable tape, the clamping apparatus having a first side and a second side, the clamping apparatus comprising:
a guide block defined by a body, the guide block including:
a passage extending through the guide block from a forward end of the guide block to a rear end;
an anvil bracket;
a clamp body;
a pivot lever;
at least one clamp spring providing a clamp force between the anvil bracket and the clamp body;
at least one anvil spring providing a welding force between the anvil bracket and the guide block; and
an anvil;
wherein the anvil bracket, the clamp body, and the anvil are configured to slidably move in a forward and rear direction through the passage;
wherein the pivot lever is configured to pivotably rotate about an axis and impart a translational movement onto the anvil bracket in response to a driving mechanism.

2. The apparatus of claim 1, wherein the clamping assembly is configured to complete a series of steps based on the translational movement of the pivot lever.

3. The apparatus of claim 1, wherein the pivot lever further comprises:
a first lever arm,
wherein the first lever arm includes a first guide wheel in rolling engagement with the driving mechanism,
a second lever arm,
wherein the second lever arm includes a second guide wheel in rolling engagement with the anvil bracket, and
a third lever arm,
wherein the third lever arm comprises being configured to pivotably mount to the guide block.

4. The apparatus of claim 1, further comprising:
a first bearing;
wherein the anvil bracket includes a first aperture configured to receive the first bearing;
wherein the clamp bracket includes a second aperture configured to receive the first bearing;
wherein the first bearing is disposed in the first aperture and the second aperture in the passage of the guide block.

5. The apparatus of claim 1, further comprising:
a second bearing;
wherein the anvil bracket includes a third aperture configured to receive the second bearing;
wherein the clamp bracket is configured to accommodate, at least in part, the second bearing;
wherein the second bearing is disposed in the third aperture in the passage of the guide block.

6. The apparatus of claim 1, wherein the at least one clamp spring comprises:
a first clamp spring, and
a second clamp spring,
wherein the first clamp spring and the second clamp spring are disposed on opposites sides of the guide block.

7. The apparatus of claim 1, wherein the at least one anvil spring comprises:
a first anvil spring, and
a second anvil spring,
wherein the first anvil spring and the second anvil spring are disposed on opposite sides of the guide block.

8. The apparatus of claim 1, wherein the guide block further includes:
a first part disposed on the first side,
a second part disposed on the second side,
wherein the first member and the second member are configured to form the guide block.

9. The apparatus of claim 1, wherein the clamp body comprises a first member and further includes a second member disposed at the forward end of the clamp body configured to engage the weldable tape during a bundling operation.

10. The apparatus of claim 1, wherein the anvil comprises:
a first anvil arm,
a second anvil arm,
a slot extending through each of the first anvil arm and the second anvil arm,
a pin fixedly disposed in the passage of the guide block and extending through each slot of the first anvil arm and the second anvil arm
wherein the first anvil arm and the second anvil arm are configured to outwardly extend when moving in the forward direction and inwardly retract when moving in the rear direction based on the slot and pin configuration.

11. A tool for bundling a plurality of elongate articles using weldable tape, the tool having a first side and a second side and comprising:
a clamping assembly including:
a guide block defining a body, the guide block including:
a passage extending through the guide block from a forward end to the rear end of the guide block,
an anvil bracket,
a clamp body,
an anvil,
a pivot lever,
at least one clamp spring providing a clamping force between the clamp body and the anvil bracket,
at least one anvil spring providing a welding force between the anvil bracket and the guide block,
a first bearing,
a second bearing,
wherein the anvil bracket, the clamp body, and the anvil are configured to slidably move in a forward and rear direction through the passage;
wherein the pivot lever is configured to pivotably rotate about an axis and impart a translational movement onto the anvil bracket in response to a driving mechanism.

12. The tool of claim 11, wherein the clamping assembly is configured to complete a series of steps based on the translational movement of the pivot lever.

13. The tool of claim 11, wherein the pivot lever further comprises:
a first lever arm,
wherein the first lever arm includes a first guide wheel in rolling engagement with the driving mechanism,
a second lever arm,
wherein the second lever arm includes a second guide wheel in rolling engagement with the anvil bracket, and
a third lever arm,
wherein the third lever arm comprises being configured to pivotably mount to the guide block.

14. The tool of claim 11, further comprising:
wherein the anvil bracket includes a first aperture configured to receive the first bearing;
wherein the clamp bracket includes a second aperture configured to receive the first bearing;
wherein the first bearing is disposed in the first aperture and the second aperture in the passage of the guide block.

15. The tool of claim 11, further comprising:
wherein the anvil bracket includes a third aperture configured to receive the second bearing;
wherein the clamp bracket is configured to accommodate, at least in part, the second bearing;
wherein the second bearing is disposed in the third aperture in the passage of the guide block.

16. The tool of claim 11, wherein the at least one clamp spring comprises:
a first clamp spring, and
a second clamp spring,
wherein the first clamp spring and the second clamp spring are disposed on opposites sides of the guide block.

17. The tool of claim 11, wherein the at least one anvil spring comprises:
a first anvil spring, and
a second anvil spring,
wherein the first anvil spring and the second anvil spring are disposed on opposite sides of the guide block.

18. The tool of claim 11, wherein the guide block further includes:
a first part disposed on the first side,
a second part disposed on the second side,
wherein the first member and the second member are configured to form the guide block.

19. The tool of claim 11, wherein the clamp body comprises a first member and further includes a second member disposed at the forward end of the clamp body configured to engage the weldable tape during a bundling operation.

20. The tool of claim 11, wherein the anvil comprises:
a first anvil arm,
a second anvil arm,
a slot extending through each of the first anvil arm and the second anvil arm,
a pin fixedly disposed in the passage of the guide block and extending through each slot of the first anvil arm and the second anvil arm
wherein the first anvil arm and the second anvil arm are configured to outwardly extend when moving in the forward direction and inwardly retract when moving in the rear direction based on the slot and pin configuration.
